(19) United States
(12) Patent Application Publication
(10) Pub. No.: US 2009/0172002 A1
(43) Pub. Date: Jul. 2, 2009

(54) System and Method for Generating Hyperlinks

(76) Inventor: Mohamed Nooman Ahmed, Louisville, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(21) Appl. No.: 11/964,104

(22) Filed: Dec. 26, 2007

(51) Int. Cl. G06F 17/30

(52) U.S. Cl. 707/102; 707/E17.005

(57) ABSTRACT

A method, computer program product, and scanning system for scanning a physical document to generate an original image-based file. The original image-based file is processed to extract text from the original image-based file and generate a text-based file. The text-based file is processed to identify one or more hyperlinks included within the text-based file. The original image-based file is modified to include the one or more hyperlinks identified within the text-based file, thus generating a modified image-based file.

### TECHNICAL FIELD

This disclosure relates to hyperlinks and, more particularly, to hyperlinks that are automatically generated while scanning a document.

### BACKGROUND

In a typical business, it may be necessary to convert paper documents to electronic images. The purpose of this conversion may be, for example, archival purposes or for dissemination to others for editing, review and/or other action. Scanned documents may include text, images, graphs, and hyperlinks to other documents or web pages.

Once a document is scanned, the resulting image file may be processed, using optical character recognition (OCR) software, to convert the non-editable image-based file to an editable text-based file. Unfortunately, any hyperlinks that are embedded within the editable text-based file may not function as hyperlinks and will merely be strings of characters.

### SUMMARY

In an implementation, a method includes scanning a document to generate an original image-based file. Text is extracted from the original image-based file and a text-based file is generated. One or more hyperlinks included within the text-based file are identified. The original image-based file is modified to include the one or more hyperlinks identified.

One or more of the following features may be included. The modified image-based file may be a multi-layer image-based file. The modified image-based file may include a first layer including the original image-based file and a second layer including the one or more hyperlinks identified.

Modifying the original image-based file may include rendering a first layer of the modified image-based file that includes the original image-based file and rendering a second layer of the modified image-based file that includes the one or more hyperlinks identified. The one or more hyperlinks of the second layer of the modified image-based file may be rendered in a color that contrasts with at least a portion of the original image-based file. The original image-based file may include graphical representations of the one or more hyperlinks.

Modifying the original image-based file may include positioning the one or more hyperlinks included within the text-based file proximate to graphical representations of the one or more hyperlinks included within the original image-based file. Identifying one or more hyperlinks may include scanning the text-based file for the occurrence of at least one of one or more hyperlink prefixes and one or more hyperlink suffixes.

Extracting text may include defining a threshold for at least a portion of the original image-based file to generate a binary interpretation of at least a portion of the original image-based file. One or more connected components may be identified in at least a portion of the binary interpretation of the image-based file. A connected component may be a plurality of same-value connected pixels, The method may also include determining if the one or more connected components is text. Extracting text may further include dividing the original image-based file into a plurality of portions.

In another implementation, a computer program product resides on a computer readable medium that has a plurality of instructions stored on it. When executed by a processor, the instructions cause the processor to perform operations including scanning a document to generate an original image-based file. Text is extracted from the original image-based file, and a text-based file is generated One or more hyperlinks included within the text-based file are identified. The original image-based file is modified to include the one or more hyperlinks identified.

One or more of the following features may be included. The modified image-based file may be a multi-layer image-based file. The modified image-based file may include a first layer including the original image-based file and a second layer including the one or more hyperlinks identified.

The instructions for modifying the original image-based file may include rendering a first layer of the modified image-based file that includes the original image-based file and rendering a second layer of the modified image-based file that includes the one or more hyperlinks identified. The one or more hyperlinks may be rendered in a color that contrasts with at least a portion of the original image-based file. The original image-based file may include graphical representations of the one or more hyperlinks.

The instructions for modifying the original image-based file may include positioning the one or more hyperlinks identified proximate to the graphical representations. The instructions for identifying the one or more hyperlinks may include scanning the text-based file for the occurrence of at least one of one or more hyperlink prefixes and one or more hyperlink suffixes.

The instructions for extracting text may include defining a threshold for at least a portion of the original image-based file to generate a binary interpretation of at least a portion of the original image-based file. One or more connected components may be identified in the binary interpretation. A connected component may be a plurality of same-value connected pixels. The instructions may also include determining if the one or more connected components is text. The instructions for extracting text may further include dividing the original image-based file into a plurality of portions.

In another implementation, a scanning system includes one or more scanning components for scanning a document to generate an original image-based file. Processing logic is configured for extracting text from the original image-based file and generating a text-based file. One or more hyperlinks included within the text-based file may be identified. The original image-based file is modified to include the one or more hyperlinks identified.

One or more of the following features may be included. The modified image-based file may be a multi-layer image-based file. The modified image-based file may include a first layer including the original image-based file and a second layer including the one or more hyperlinks identified.

Modifying the original image-based file may include rendering the first layer of the modified image-based file that includes the original image-based file and rendering the second layer of the modified image-based file that includes the one or more hyperlinks identified. The one or more hyperlinks of the second layer of the modified image-based file may be rendered in a color that contrasts with at least a portion of the original image-based file. The original image-based file may include graphical representations of the one or more hyperlinks identified.

Modifying the original image-based file may include positioning the one or more hyperlinks identified proximate to the graphical representations. Identifying one or more hyperlinks may include scanning the text-based file for the occurrence of at least one of one or more hyperlink prefixes and one or more hyperlink suffixes.

Extracting text may include defining a threshold for at least a portion of the original image-based file to generate a binary interpretation of at least a portion of the original image-based file. One or more connected components in at least a portion of the binary interpretation of the image-based file may be identified. A connected component may be a plurality of same-value connected pixels. Extracting text may also include determining if the connected component is text. Extracting text may further include dividing the original image-based file into a plurality of portions.

The details of one or more implementations are set forth in the accompanying drawings and the description below. Other features and advantages will become apparent from the description, the drawings, and the claims.

### BRIEF DESCRIPTION OF THE DRAWINGS

FIG. 1 is a diagrammatic view of a hyperlink generation process executed by a printing-scanning system coupled to a distributed computing network;

FIG. 2 is a diagrammatic view of the printing-scanning system of FIG. 1;

FIG. 3 is a flowchart of the hyperlink generation process of FIG. 1;

FIG. 4 is a diagrammatic view of a display screen rendered by the hyperlink generation process of FIG. 1;

FIG. 5 is a diagrammatic view of a pixel-based graphical representation of a text character; and

FIG. 6 is a diagrammatic view of a text character comparison process performed by the hyperlink generation process of FIG. 1.

Like reference symbols in the various drawings indicate like elements.

### DETAILED DESCRIPTION

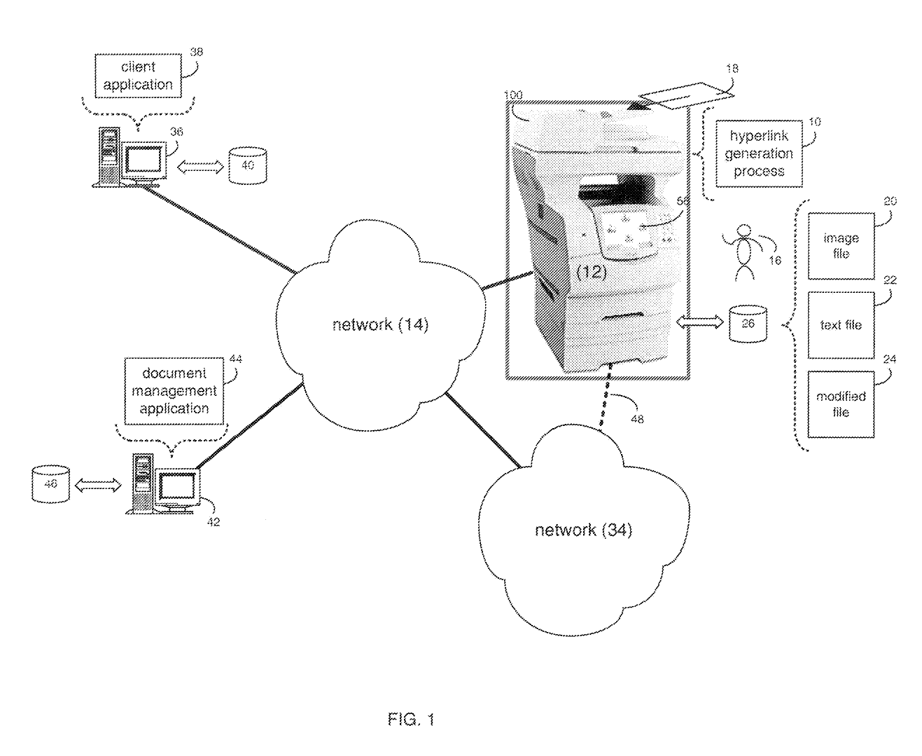

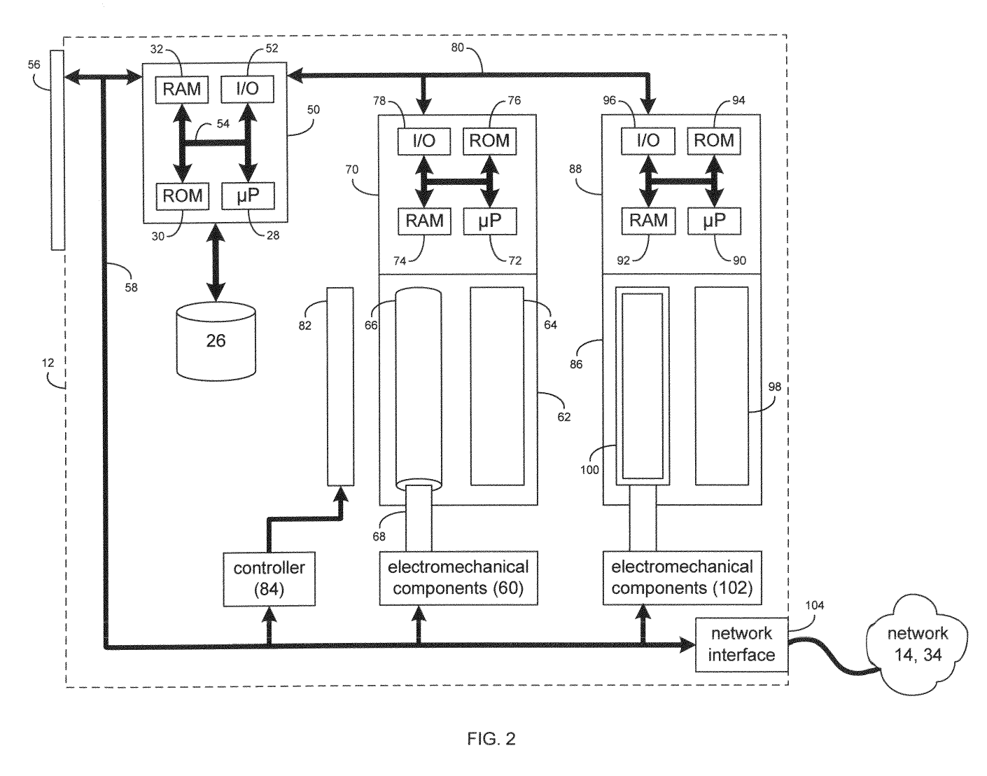

Referring to FIGS. 1 and 2, there is shown a hyperlink generation process 10 that may reside on and may be executed by printing-scanning system 12, which may be connected to a network 14 (e.g., the Internet, a local area network, or a wide area network). Examples of printing-scanning system 12 may include, but are not limited to: an inkjet printing-scanning system, a laser printing-scanning system, and a multifunction printing-scanning system. An example of such a multifunction printing-scanning system is a Lexmark X850e and a Lexmark X646e, both of which are available from Lexmark International, Inc. of Lexington, Ky.

As will be discussed below in greater detail, hyperlink generation process 10 may allow user 16 to scan a physical document 18 to generate an original image-based file 20. Original image-based file 20 may be processed to extract text from original image-based file 20 and generate text-based file 22. Text-based file 22 may be processed to identify one or more hyperlinks included within text-based file 22. Original image-based file 20 may be modified to include the one or more hyperlinks identified within text-based file 22, thus generating modified image-based file 24.

The instruction sets and subroutines of hyperlink generation process 10, which may be stored on storage device 26 operatively coupled to printing-scanning system 12, may be executed by one or more processors (e.g., microprocessor 28) and one or more memory architectures (e.g., read-only memory (i.e., ROM) 30, random access memory (i.e., RAM) 32) incorporated into printing-scanning system 12. Storage device 26 may be an internal storage device included or embedded within printing-scanning system 12. In an alternate embodiment, storage device 26 may also be attached to printing-scanning system 12. Examples of storage device 26 may include but are not limited to: a hard disk drive; a tape drive; an optical drive; a RAID array; a random access memory; a read-only memory; a compact flash (CF) storage device, a secure digital (SD) storage device, and a memory stick storage device. Printing-scanning system 12 may execute an operating system, examples of which may include but are not limited to a Unix™ based operating system and a Linux™ based operating system.

Network 14 may be coupled to one or more secondary networks (e.g., network 34), examples of which may include, but are not limited to, a local area network, a wide area network, or an intranet.

Client computer 36 may execute client application 38 that may facilitate the viewing of modified image-based file 24. An example of client application 38 may include, but is not limited to, Adobe Acrobat Reader™ available from Adobe Systems Incorporated of San Jose, Calif. The instruction sets and subroutines of client application 38, which may be stored on storage device 40 coupled to client computer 36, may be executed by one or more processors (not shown) and one or more memory architectures (not shown) incorporated into client computer 36. Examples of client computer 36 may include, but are not limited to, a personal computer, a laptop computer, a notebook computer, a personal digital assistant, and a data enabled cellular telephone. Client computer 36 may execute an operating system, examples of which may include, but are not limited to, Microsoft Windows XP™ or Redhat Linux™.

Once printing-scanning system 12 scans physical document 18 and generates modified image-based file 24, a copy of modified image-based file 24 may be stored on server computer 42. Server computer 42 may execute a document management program 44, examples of which may include but are not limited to iManage™ available from Interwoven, Inc. of Sunnyvale, Calif. The instruction sets and subroutines of document management program 44, which may be stored on storage device 46 coupled to server computer 42 may be executed by one or more processors (not shown) and one or more memory architectures (not shown) incorporated into server computer 42. Examples of server computer 42 may include, but are not limited to, a personal computer, a server computer, a series of server computers, a mini computer, and a mainframe computer. Server computer 42 may be a web server (or a series of servers) running a network operating system, examples of which may include, but are not limited to, Microsoft Windows XP Sever™, Novell Netware™; or Redhat Linux™.

Client computer 36 and/or server computer 42 may access printing-scanning system 12 directly through network 14 or through secondary network 34. Further, printing-scanning system 12 may be connected to network 14 through secondary network 34, as illustrated with phantom link line 48. In an alternate embodiment, printing-scanning system 12 may be directly or locally attached to client computer 36.

Printing-scanning system 12 may include system board 50 for controlling the operation of printing-scanning system 12. System board 50 may include microprocessor 28, ROM 30, RAM 32, and an input/output (I/O) controller 52. Microprocessor 28, ROM 30, RAM 32, and I/O controller 52 may be coupled to each other via data bus 54. Examples of data bus 54 may include, but are not limited to, a Peripheral Component Interconnect (PCI) bus, an Industry Standard Architecture (ISA) bus, an Inter-IC (I2C) bus, a Serial Peripheral Interconnect (SPI) bus or a proprietary bus.

Printing-scanning system 12 may include display panel 56 for rendering a user interface and providing information to e.g., user 16. Display panel 56 may include, for example, a liquid crystal display (LCD) panel, one or more light emitting diodes (LEDs), and one or more switches. Display panel 56 may also be a touch-screen display panel that is finger navigatable by user 16. Display panel 56 may be coupled to I/O controller 52 of system board 50 via data bus 58. Examples of data bus 58 may include, but are not limited to, a PCI bus, an ISA bus, an I2C bus, an SPI bus or a proprietary bus. Printing-scanning system 12 may include electromechanical components 60 for controlling the movement of paper through printing-scanning system 12. Examples of electromechanical components 60 may include but are not limited to: feed motors (not shown), gear drive assemblies (not shown), paper jam sensors (not shown), and paper feed guides (not shown). Electromechanical components 60 may be coupled to system board 50 via data bus 58.

Printing-scanning system 12 may include printer cartridge 62. Printer cartridge 62 may include, for example, toner reservoir 64 and toner drum assembly 66. Electromechanical components 60 may be mechanically coupled to printer cartridge 62 via a releasable gear assembly 68 that allows printer cartridge 62 to be easily removed from printing-scanning system 12.

Printer cartridge 62 may include system board 70 that controls the operation of printer cartridge 62. System board 70 may include, for example, microprocessor 72, RAM 74, ROM 76, and I/O controller 78. System board 70 may be releasably coupled to system board 50 via data bus 80, thus allowing for the removal of printer cartridge 62 from printing-scanning system 12. Examples of data bus 80 may include, but are not limited to, a PCI bus, an ISA bus, an I2C bus, an SPI bus or a proprietary bus.

Printing-scanning system 12 may include a fusing device 82 for affixing the toner (supplied by toner reservoir 64 and applied by toner drum assembly 66) to the media (e.g., paper) being processed by printing-scanning system 12. The temperature of fusing device 82 may be controlled by controller 84. Controller 84 may be coupled to system board 50 via data bus 58. Alternatively, controller 84 may be incorporated into system board 50.

Printing-scanning system 12 may include scanner assembly 86 for scanning documents. Scanner assembly 86 may include a system board 88 that controls the operation of scanner assembly 86. System board 88 may include a microprocessor 90, RAM 92, ROM 94, and I/O controller 96. System board 88 may be coupled to system board 50 via data bus 80. Scanner assembly 86 may include a light source 98 and light receptor 100, such as one or more charge coupled devices. Electromechanical components 102 may move the document being scanned (e.g., physical document 18) with respect to light source 98 and light receptor 100. Alternatively, electromechanical components 102 may move light source 98 and light receptor 100 with respect to the document being scanned (e.g., physical document 18).

Printing-scanning system 12 may include network interface 104 for allowing printing-scanning system 12 to interface with networks 14, 34 and to provide modified image-based file 24 to client computer 36 and/or server computer 42.

While hyperlink generation process 10 is illustrated using printing-scanning system 12, it will be appreciated by one of ordinary skill in the art that hyperlink generation process 10 may also be used in connection with scanning systems not capable of printing.

As discussed above, hyperlink generation process 10 may allow user 16 to scan physical document 18 to generate original image-based file 20. Original image-based file 20 may be processed to extract text from original image-based file 20 and generate text-based file 22. Text-based file 22 may be processed to identify one or more hyperlinks included within text-based file 22. Original image-based file 20 may be modified to include the one or more hyperlinks identified within text-based file 22, thus generating modified image-based file 24. As discussed above, printing-scanning system 12 may execute an operating system, examples of which may include but are not limited to a Unix™ based operating system and a Linux™ based operating system. Hyperlink generation process 10 may be any I application capable of being executed on printing-scanning system 12 utilizing the above-described operating system. An example of one such application is a Java™ application. The application may be executed locally on printing-scanning system 12 or over network 14 or network 34.

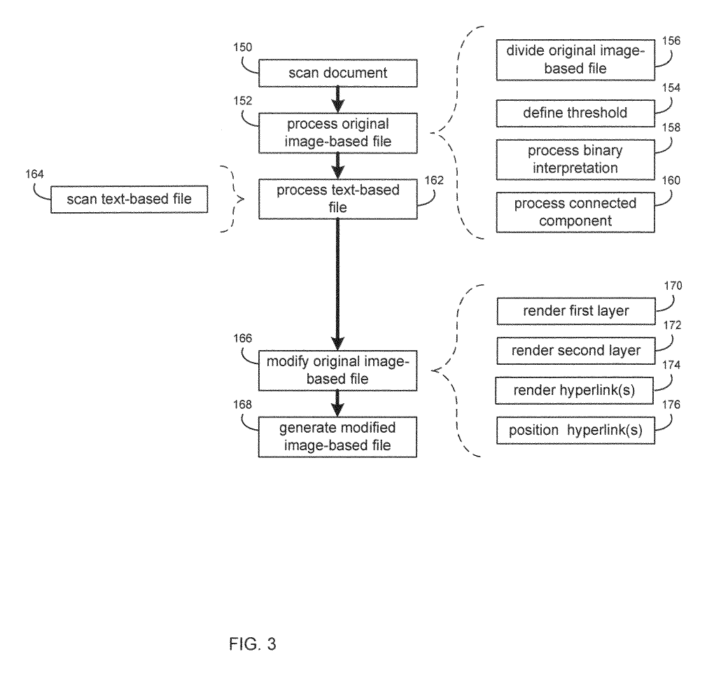

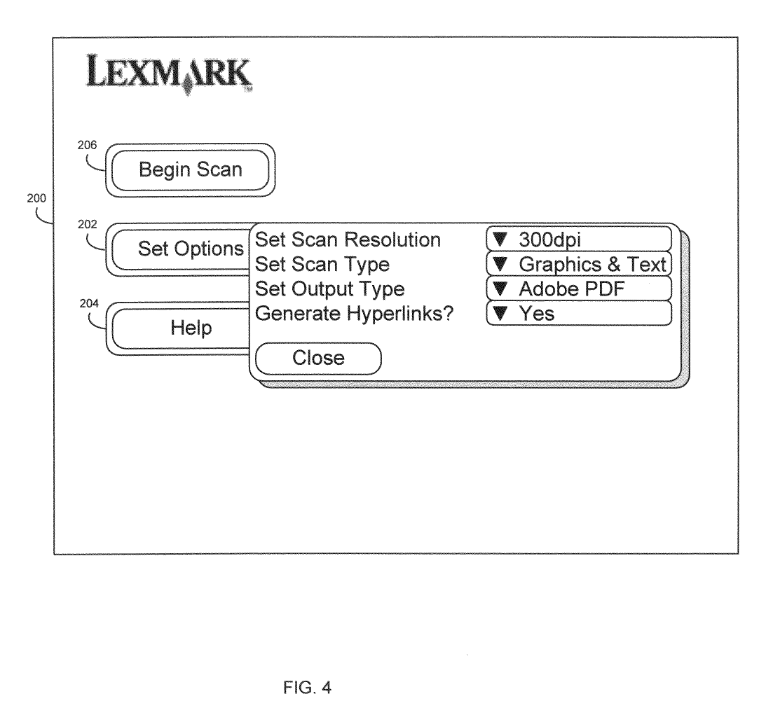

As discussed above, printing-scanning system 12 may include scanner assembly 86 for e.g., scanning documents. Referring also to FIGS. 3 and 4, hyperlink generation process 10 may allow user 16 to scan physical document 18 to generate original image-based file 20 (block 150). User 16 may initiate the scanning of physical document 18 via user interface 200 rendered on display panel 54 by hyperlink generation process 10.

Prior to initiating the scanning of physical document 18, hyperlink generation process 10 may allow user 16 to set or define options for the scan by activating or selecting the “Set Options” button 202. Examples of the type of options available may include, but are not limited to, setting scan resolution, setting scan type, setting output type and generating Hyperlinks.

If user 16 chooses to set the scan resolution, hyperlink generation process 10 may allow user 16 to select between various resolutions, examples of which may include, but are not limited to, 100 dpi, 200 dpi, 300 dpi and 400 dpi. If user 16 chooses to set the scan type, hyperlink generation process 10 may allow user 16 to select between various scan types, examples of which may include, but are not limited to, text only, graphics only and text and graphics. If user 16 chooses to set the output type, hyperlink generation process 10 may allow user 16 to select between various output types, examples of which may include, but are not limited to, JPEG format, Microsoft Word document and PDF format. If user 16 chooses to generate hyperlinks, hyperlink generation process 10 may convert text to hyperlinks for inclusion within modified image-based file 24. If user 16 has any questions concerning the scanning process, user 16 may obtain help by selecting or activating the “Help” button 204.

Once user 16 has selected the appropriate options, user 16 may select or activate the “Begin Scan” button 206. Assuming that user 16 selected “Yes” with respect to the “Generate Hyperlinks?” option, hyperlink generation process 10 may scan physical document 18 to generate original image-based file 20.

Once physical document 18 is scanned and original image-based file 20 is generated, hyperlink generation process 10 may process original image-based file 20 to extract text from original image-based file 20 and generate text-based file 22 at block 152. Processing original image-based file 20 to extract text from original image-based file 20 may be accomplished using various optical character recognition (OCR) techniques.

Optical character recognition is a computer application that allows for the translation of computer images (e.g., original image-based file 20) that are usually captured via a scanning process into machine-editable text (e.g., text-based file 22). Conventional optical character recognition applications may achieve accuracy rates of 99% or greater.

Systems for recognizing hand-printed text in real time have also enjoyed commercial success in recent years. Examples of such systems may include but are not limited to the input device for some personal digital assistants (e.g. Palm™ OS based devices). Such systems often achieve accuracy rates of 80-90%. This variety of OCR may be referred to as Intelligent Character Recognition (ICR).

Prior to an OCR application processing a document, the document may be scanned using an optical scanner. For example scanner assembly 86 included within printing-scanning system 12 may be utilized to scan physical document 18 and generate original image-based file 20. Once scanned, the OCR application may process the resulting scanned images to differentiate between images and text and to determine what text characters are represented in the light and dark areas of the scanned images, etc.

Conventional OCR applications may attempt to match portions of these scanned images with stored bitmaps that are based on specific characters included within specific fonts. Unfortunately, this may result in less-than-optimal results. More recent OCR applications may utilize multiple algorithms (examples of which will be discussed below in greater detail) to analyze, for example, the stroke edge (i.e., the line of discontinuity between the text characters and the background), white spaces, character shapes and/or character curvatures. In order to allow for irregularities of printed ink on paper, such algorithms may average the light and dark value along the side of a stroke, match this value to known characters and make a best guess as to the character scanned. The OCR application may then average the results from all algorithms to obtain a single reading.

While the following disclosure describes a specific OCR technique, this is for illustrative purposes only and is not intended to be a limitation of this disclosure. Specifically, the manner in which original image-based file 20 is processed to generate text-based file 22 is not important. Accordingly, the following description is merely intended to be one example of the manner in which the desired result (i.e., the conversion of original image-based file 20 to text-based file 22) may be achieved.

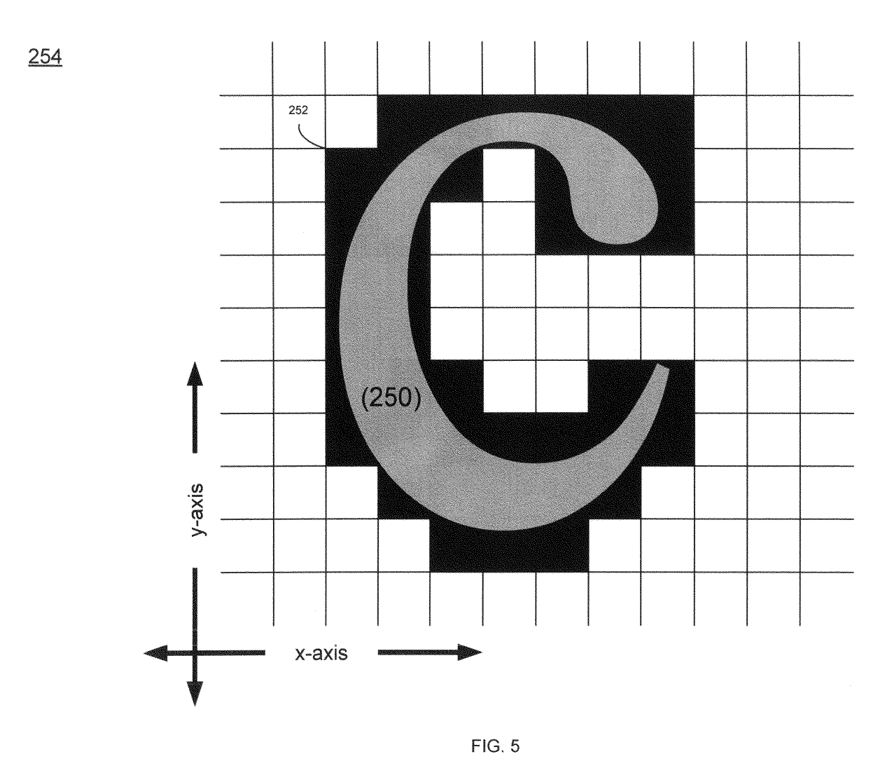

Referring also to FIG. 5, when original image-based file 20 is generated, original image-based file 20 may include pixel-based graphical representations of one or more text-based characters and one or more hyperlinks if original image-based file 20 includes such hyperlinks. For example, assume that physical document 18 includes the letter “c” 250. Upon scanning physical document 18, a pixel-based graphical representation 252 of the letter “c” 250 (in the form of pixel matrix 254) may be included within original image-based file 20. Obviously, as the resolution of the scan is increased (e.g., from 200 dpi to 400 dpi) along the x-axis and/or the y-axis, the accuracy of pixel-based graphical representation 252 of the letter “c” 250 may be increased. Conversely, decreasing the resolution of the scan (e.g., from 400 dpi to 200 dpi) along the x-axis and/or the y-axis may result in the accuracy of pixel-based graphical representation 252 of the letter “c” 250 being decreased.

Once original image-based file 20 is generated, hyperlink generation process 10 may process original image-based file 20 to extract text from original image-based file 20 and generate text-based file 22 (as shown in block 152 of FIG. 5).

When processing original image-based file 20 to extract text and generate text-based file 22, hyperlink generation process 10 may define at block 154 a threshold for at least a portion of original image-based file 20 to generate a binary interpretation of at least a portion of original image-based file 20. When defining the threshold, hyperlink generation process 10 may define an initial threshold value, wherein the threshold value may be used by hyperlink generation process 10 to determine whether a specific pixel is a binary “1” (e.g., a black pixel) or a binary “0” (e.g., a white pixel). For example, assume that when original image-based file 20 is generated, an eight-bit pixel depth is utilized. Accordingly, the individual pixels within original image-based file 20 may be one of two hundred fifty-six (i.e., 28) shades of gray (assuming that original image-based file is a grayscale image). According, hyperlink generation process 10 may define 154 the initial threshold value to be one hundred twenty-seven (i.e., the median value of the grayscale range), wherein 0-127 represents a white (i.e., “0”) pixel and 128-255 represents a black (i.e., “1”) pixel.

However, scenarios can be imagined in which a threshold positioned right in the middle (i.e., at the median) of the grayscale spectrum may not produce desirable results. For example, for an original image-based file 20 that is overly light, the binary representation of the original image-based file 20 may appear to be mostly white (resulting in a loss of detail) if a median threshold value is utilized. Conversely, for an original image-based file 20 that is overly dark, the binary representation of the original image-based file 20 may appear to be mostly black (also resulting in a loss of detail) if a median threshold value is utilized.

Accordingly, hyperlink generation process 10 may define the threshold of original image-based file 20 to be the actual average pixel value. For example, hyperlink generation process 10 may set an initial threshold value to be the median grayscale spectrum value (e.g., “127”), wherein 0-127 represents a white (i.e., “0”) pixel and 128-255 represents a black (i.e., “1”) pixel. The pixels within original image-based file 20 (or a portion thereof) may be processed to segment the pixels into two groups, namely white (i.e., binary “0”) pixels and black (i.e., binary “1”) pixels. Once these two pixel groups are defined, hyperlink generation process 10 may determine the average value for each pixel group. Assume for illustrative purposes that original image-based file 20 is an overly light image. Further, assume that when using the median threshold value of “127”, 80% of the processed pixels are considered binary “0” (i.e., white) pixels and 20% of the processed pixels are considered binary “1” (i.e., black) pixels. Further, assume that white (i.e., binary “0”) pixels range from 0-127 and have an average value of forty-three. Further, assume that black (i.e., binary “1”) pixels range from 128-160 and have an average value of one-hundred-forty-one. Hyperlink generation process 10 may recalculate the threshold to be the average value of the binary “0” pixel group and the binary “1” pixel group. Accordingly, the new threshold value may be calculated as follows:

$$T = \frac{1}{2} ( 43 + 141 )$$

for a new threshold value of ninety-two. The pixels within the original image-based file 20 (or a portion thereof) may then be reprocessed using this adjusted threshold value of ninety-two to segment the pixels into two new groups, namely white (i.e., binary “0”) pixels and black (i.e., binary “1”) pixels. Once these two new pixel groups are defined, hyperlink generation process 10 may again determine the average value for each pixel group and the threshold value may again be adjusted. Hyperlink generation process 10 may repeat this iterative threshold adjustment process until the percentage of change between the new threshold value and the previously-determined threshold value is less than a preset or predetermined percent, such as 1%. Once such a criterion is achieved, hyperlink generation process 10 may define a “final” threshold value for original image-based file 20 (or a portion thereof).

Prior to defining a threshold value, hyperlink generation process 10 may divide original image-based file 20 into a plurality of portions (block 156), and a threshold value may be calculated for each of the plurality of portion. For example, assume that physical document 18 is a two-column document and, therefore, original image-based file 20 is a scan of a two-column document. Further, assume that the first column has a white background and assume that the second column has a dark gray background. Accordingly, if a single threshold value is establish for the entire document, the binary interpretation of one of the two columns may not have the required level of detail. Accordingly, hyperlink generation process 10 may divide the document into a plurality of portions and generate a threshold value for each portion. Accordingly, portions that include the first column (i.e., the white background column) may have a lower threshold value and portions that include the second column (i.e., the dark gray background column) may have a higher threshold value.

Continuing with the above-stated example, as show in FIG. 5, pixel-based graphical representation 252 of the letter “c” 250 may be indicative of the binary interpretation of the letter “c”. Once the binary interpretation is generated, hyperlink generation process 10 may process at block 158 of FIG. 3 at least a portion of the binary interpretation of image-based file 20 to identify one or more connected components. An example of a connected component may include but is not limited to a plurality of same-value connected pixels. For example, hyperlink generation process 10 may consider a group of connected binary “1” (i.e., black) pixels to be a connected component. Additionally or alternatively, hyperlink generation process 10 may consider a group of connected binary “0” (i.e., white) pixels to be a connected component.

Continuing with the above-stated example in which a binary interpretation of the letter “c” is generated, hyperlink generation process 10 may process the portion of the binary interpretation of image-based file 20 (as represented by pixel matrix 254) to identify one or more connected components. In this particular example, a connected component is the combination of the forty-one pixels that make up the binary interpretation of the letter “c”. Hyperlink generation process 10 may define rules concerning what constitutes a connected component. For example, a group of three or less connected pixels may not be considered by hyperlink generation process 10 to be a connected component, while a group of four or more connected pixels may be considered to be a connected component.

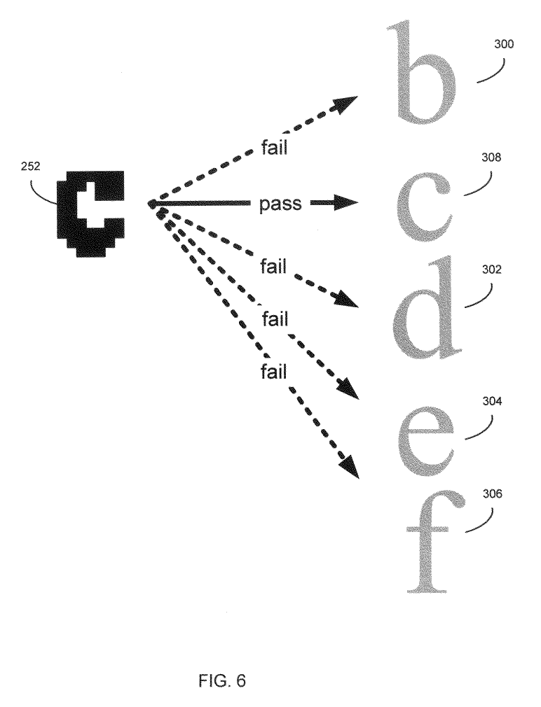

Once hyperlink generation process 10 defines one or more connected components (in this example, the group of forty-one pixels that make up the binary interpretation of the letter “c”), hyperlink generation process 10 may process at block 160 at least one of the connected components to determine if the connected component being processed is text. For example, referring to FIG. 6, hyperlink generation process 10 may sequentially compare pixel-based graphical representation 252 to the text characters recognized by hyperlink generation process 10. For example, hyperlink generation process 10 may compare pixel-based graphical representation 252 to text characters “b” 300, “d” 302, “e” 304 and “f” 306, each of which would fail. Accordingly, hyperlink generation process 10 would deem pixel-based graphical representation 252 not to be representative of a “b”, “d”, “e” or “f” character. However, when comparing pixel-based graphical representation 252 to text character “c” 308, the comparison would pass. Accordingly, hyperlink generation process 10 would deem pixel-based graphical representation 252 (the previously-defined connected component) to be representative of text-character “c”. Hyperlink generation process 10 may process each connected component identified within original image-based file 20.

Once hyperlink generation process 10 has completed processing original image-based file 20, text-based file 22 that is indicative of the text included within original image-based file 20 may be generated. Text based file 22 may be editable by a word processor program, such as Microsoft Word™ available from The Microsoft Corporation of Redmond, Wash.

Once text-based file 22 is generated, hyperlink generation process 10 may process text-based file 22 to identify one or more hyperlinks included within the text-based file 22 at block 162. For example, hyperlink generation process 10 may scan the text defined within text-based file 22 for the occurrence of at least one of one or more hyperlink prefixes and one or more hyperlink suffixes (block 164). Examples for hyperlink prefixes may include but are not limit to “http:\\”, “https:\\”, “www.” and “ftp.”. Examples of hyperlink suffixes may include but are not limited to “.html”, “htm”, “.com”, “.net”, “org” and “.edu”. Upon hyperlink generation process 10 identifying these prefixes and/or suffixes, hyperlink generation process 10 may define the entire hyperlink as all characters between the beginning of the prefix and the end of the suffix. Accordingly, if, for example, while scanning 164 the text defined within text-based file 22, hyperlink generation process 10 identifies the hyperlink prefix “www.” and the hyperlink suffix “.com” with “lexmark” positioned between the identified prefix and suffix, hyperlink generation process 10 may identify the entire text as a hyperlink of “www.lexmark.com”. Once the hyperlink is identified, hyperlink generation process 10 may associate the uniform resource locator (URL) “www.lexmark.com” with the identified hyperlink.

Hyperlink generation process 10 may modify original image-based file 20 to include the hyperlinks identified within text-based file 22 at block 166, thus generating modified image-based file 24 (block 168). Modified image-based file 24 may be a multi-layer image-based file that may include: a first layer including original image-based file 20, and a second layer including the one or more hyperlinks (e.g., www.lexmark.com) identified within the text of text-based file 22.

When modifying original image-based file 20 to form modified image-based file 24, hyperlink generation process 10 may render the first layer of modified image-based file 24 that includes original image-based file 20 at block 170 and may render the second layer of modified image-based file 24 that includes the hyperlinks (e.g., www.lexmark.com) identified within the text of text-based file 22 block 172. When rendering the layers to form modified image-based file 24, each upper-level layer that is positioned on top of a lower-level layer may be rendered with a defined level of transparency (e.g. 50%), thus preventing the lower-level layer from being obscured by the upper-level layer.

Text-based file 22 (and, therefore, the second layer of modified image-based file 24) may be similar in size to original image-based file 20 (and, therefore, the first layer of modified image-based file 24). Accordingly, by properly positioning the identified hyperlinks within text-based file 22 and properly positioning the second layer of modified image-based file 24 with respect to the first layer of modified image-based file 24, the identified hyperlinks from the second layer of modified image-based file 24 may be properly positioned with respect to original image-based file 20 from the first layer of modified image-based file 24.

As discussed above, hyperlink generation process 10 may divide at block 156 original image-based file 20 into a plurality of portions, and each of these portions may be subsequently processed. Accordingly, when a connected component is processed (block 160) and subsequently deemed to be representative of a text-character, hyperlink generation process 10 may determine the position of the text character (e.g., text character “c”) within original image-based file 20 by knowing the position of the scanned portion (e.g., pixel matrix 254) within original image-based file 20. Accordingly, hyperlink generation process 10 may properly position the identified hyperlinks (e.g. www.lexmark.com) within text-based file 22.

Hyperlink generation process 10 may render the hyperlinks of the second layer of modified image-based file 24 in a color that contrasts at least a portion of original image-based file 20, thus allowing the hyperlinks to “stand out” with respect to non-hyperlink text in original image-based file 20 (block 174). For example, the hyperlink included within the second layer of modified image-based file 24 may be rendered in a bright blue or a bright red, thus allowing them to “stand out” with respect to non-hyperlink text in original image-based file 20.

As discussed above, original image-based file 20 may include graphical representations of the hyperlinks included within text-based file 22 (i.e., the second layer of modified image-based file 24). Accordingly, when modifying original image-based file 20 to generate modified image-based file 24, hyperlink generation process 10 may position the hyperlinks included within text-based file 22 proximate to the graphical representations of the hyperlinks included within original image-based file 20 (block 176). Continuing with the above-described example in which hyperlink generation process 10 identified the hyperlink “www.lexmark.com” within original image-based file 20, when rendering modified image-based file 24, hyperlink generation process 10 may position the text-based hyperlink “www.lexmark.com” within the second layer of modified image-based file 24 so that the hyperlink is positioned on top of the image-based graphical representation of the hyperlink “www.lexmark.com” that was included within original image-based file 20.

In order to avoid the image-based graphical representation of the hyperlink “www.lexmark.com” positioned within the first layer of modified image-based file 24 being visible through the text-based hyperlink “www.lexmark.com” positioned within the second layer of modified image-based file 24, hyperlink generation process 10 may assign a fill color to the text-based hyperlink “www.lexmark.com” positioned within the second layer of modified image-based file 24 that prevents the viewing of the image-based graphical representation of the hyperlink “www.lexmark.com” positioned within the first layer of modified image-based file 24.

Once modified image-based file 24 is generated at block 168, modified image-based file 24 may be stored on server computer 42 of FIG. 1 and/or within document management application 44 and may be viewable on client application 38 that is executed on client computer 36. A user of client application 38 (not shown) may be able to click on the identified hyperlinks that are included within the second layer of modified image-based file 24 and visit the resource defined by the hyperlink.

A number of implementations have been described for purposes of illustration. It is not intended to be exhaustive or to limit the present invention to the precise actions and/or forms disclosed, and obviously many modifications and variations are possible in light of the above teaching. It is intended that the scope of the present invention be defined by the claims appended hereto.

1. A method, comprising:
scanning a document to generate an original image-based file;
extracting text from the original image-based file and generating a text-based file;
identifying one or more hyperlinks included within the text-based file; and
modifying the original image-based file to include the one or more hyperlinks identified.

2. The method of claim 1, wherein the modified image-based file is a multi-layer image-based file comprising:
a first layer including the original image-based file; and
a second layer including the one or more hyperlinks identified.

3. The method of claim 1, wherein the modifying the original image-based file comprises:
rendering a first layer of the modified image-based file that includes the original image-based file; and
rendering a second layer of the modified image-based file that includes the one or more hyperlinks identified,
wherein the one or more hyperlinks identified are rendered in a color that contrasts with at least a portion of the original image-based file.

4. The method of claim 1, wherein modifying the original image-based file includes positioning the one or more hyperlinks included within the text-based file proximate to graphical representations of the one or more hyperlinks included within the original image-based file.

5. The method of claim 1, wherein the identifying the one or more hyperlinks comprises scanning the text-based file for an occurrence of at least one of one or more hyperlink prefixes and one or more hyperlink suffixes.

6. The method of claim 1, wherein the extracting text comprises:
defining a threshold for at least a portion of the original image-based file to generate a binary interpretation of at least a portion of the original image-based file;
identifying one or more connected components in at least a portion of the binary interpretation of the image-based file, wherein the connected component is a plurality of same-value connected pixels; and
determining if the one or more of the connected components is text.

7. The method of claim 1, wherein the extracting text further comprises dividing the original image-based file into a plurality of portions.

8. A computer program product residing on a computer readable medium having a plurality of instructions stored thereon which, when executed by a processor, causes the processor to perform operations, comprising:
scanning a document to generate an original image-based file;
extracting text from the original image-based file and generating a text-based file;
identifying one or more hyperlinks included within the text-based file; and
modifying the original image-based file to include the one or more hyperlinks identified.

9. The computer program product of claim 8, wherein the instructions for modifying the original image-based file comprise:
rendering a first layer of the modified image-based file that includes the original image-based file; and
rendering a second layer of the modified image-based file that includes the one or more hyperlinks identified;
wherein the one or more hyperlinks identified are rendered in a color that contrasts with at least a portion of the original image-based file.

10. The computer program product of claim 8, wherein the original image-based file includes graphical representations of the one or more hyperlinks identified and wherein the instructions for the modifying the original image-based file comprises positioning the one or more hyperlinks identified proximate to the graphical representations.

11. The computer program product of claim 8, wherein the instructions for the identifying the one or more hyperlinks comprises scanning the text-based file for the occurrence of at least one of one or more hyperlink prefixes and one or more hyperlink suffixes.

12. The computer program product of claim 8, wherein the instructions for the extracting text comprises:
defining a threshold for at least a portion of the original image-based file to generate a binary interpretation of at least a portion of the original image-based file;
identifying one or more connected components in the binary interpretation, wherein the connected component is a plurality of same-value connected pixels; and
determining if the one or more connected components being identified is text.

13. The computer program product of claim 18, wherein the instructions for the extracting text further comprises dividing the original image-based file into a plurality of portions.

14. A scanning system, comprising:
one or more scanning components for scanning a document to generate an original image-based file; and
processing logic configured for:
extracting text from the original image-based file and generating a text-based file,
identifying one or more hyperlinks included within the text-based file, and
modifying the original image-based file to include the one or more hyperlinks identified.

15. The scanning system of claim 14, wherein the modified image-based file is a multi-layer image-based file, comprising:
a first layer including the original image-based file; and
a second layer including the one or more hyperlinks identified.

16. The scanning system of claim 14, wherein the modifying the original image-based file comprises:
rendering a first layer of the modified image-based file that includes the original image-based file; and
rendering a second layer of the modified image-based file that includes the one or more hyperlinks identified;
wherein the one or more hyperlinks of the second layer of the modified image-based file are rendered in a color that contrasts with at least a portion of the original image-based file.

17. The scanning system of claim 14, wherein the original image-based file includes graphical representations of the one or more hyperlinks identified and wherein the modifying the original image-based file comprises:
positioning the one or more hyperlinks identified proximate to the graphical representations.

18. The scanning system of claim 14, wherein the identifying one or more hyperlinks comprises scanning the text-based file for the occurrence of at least one of one or more hyperlink prefixes and one or more hyperlink suffixes.

19. The scanning system of claim 14, wherein the extracting text comprises:
defining a threshold for at least a portion of the original image-based file to generate a binary interpretation of at least a portion of the original image-based file;
identifying one or more connected components in at least a portion of the binary interpretation, wherein the connected component is a plurality of same-value connected pixels; and
determining if the connected component is text.

20. The scanning system of claim 19, wherein the extracting text comprises dividing the original image-based file into a plurality of portions.
